(19) United States
(12) Patent Application Publication
(10) Pub. No.: US 2019/0364949 A1
(43) Pub. Date: Dec. 5, 2019

(54) COMPOSITION IN POWDER FORM COMPRISING IRON-CASEIN COMPLEXES AND COMPOUNDS SENSITIVE TO OXIDATION

(71) Applicant: NESTEC S.A., Vevey (CH)

(72) Inventors: Matthieu Bedard, Thun (CH); Joeska Husny, Bern (CH)

(21) Appl. No.: 16/462,411

(22) PCT Filed: Dec. 14, 2017
(86) PCT No.: PCT/EP2017/082810

§ 371 Date: May 20, 2019

(30) Foreign Application Priority Data
Dec. 15, 2016 (EP) 16204301.2

(51) Int. Cl. A23L 33/165; A23L 33/15; A23L 33/135; A23L 33/12; A23L 33/19; A23L 2/66

(52) U.S. Cl. CPC A23L 33/165; A23L 33/15; A23L 2/66; A23L 33/12; A23L 33/19; A23L 33/135

(57) ABSTRACT

The present invention relates to a composition comprising compounds sensitive to oxidation and at least one iron-casein protein complex, wherein the complex is a non-micellar iron-casein complex comprising exogenous iron, casein and exogenous orthophosphorus. Such iron-casein complex advantageously does not cause significant oxidation of sensitive compounds such as LC-PUFAs, vitamins and polyphenols.

### FIELD OF THE INVENTION

The present invention relates to a composition comprising compounds sensitive to oxidation and at least one iron-casein protein complex, wherein the complex is a non-micellar iron-casein complex comprising exogenous iron, casein and exogenous orthophosphorus. Such iron-casein complex advantageously does not cause significant oxidation of sensitive compounds such as LC-PUFAs, vitamins and polyphenols.

### BACKGROUND OF THE INVENTION

Food products and beverages, comprise a wide variety of nutrients, which may have negative interactions with each other. This is typically the case when iron is present in a composition together with compounds sensitive to oxidation, as iron tends to oxidize such compounds, leading to undesired modification of the sensory and/or nutritional properties of such compounds.

Iron is a particularly important micro-nutrient. Worldwide, iron deficiency is one of the most prevalent nutrient deficiencies. In humans, iron is essential for the functioning of a large number of biological processes such as oxygen binding and transport, gene regulation, neurological function, immune function and regulation of cell growth and differentiation. Iron deficiency may result in anaemia, as well as a variety of health problems, such as impairment of thyroid, immune and mental functions, physical performance, cognitive development, increased sensitivity to insulin and fatigue. Iron deficiency is especially widespread in pregnant and lactating women, as well as in infants and children.

Fortification of foods with iron is one approach to combatting iron deficiency. Therefore, the inclusion of an added iron source in dietary compositions or supplements, particularly dietary compositions or supplements for infants, small children, women pre-pregnancy, during pregnancy and/or during lactation, is highly desirable. Diverse iron compounds have been used as iron fortifying agents in food products and in nutritional supplements. For example, ferrous sulphate is widely used, owing to its relatively low price and high bioavailability.

However, the present inventors have found that a number of iron compounds, when used to fortify a composition, have a deleterious effect on compounds sensitive to oxidation such as LC-PUFAs, vitamins and polyphenols.

LC-PUFAs are essential components of our diet and scientific evidence supports that specific LC-PUFAs are important for brain and retina development, heart health and a number of other health benefits. Vitamins are also essential nutrients, which are necessary for the prevention of numerous diseases and disorders. Polyphenols are also associated with health benefits and are for example associated with prevention of degenerative diseases, cardiovascular disease and cancer.

However, compounds such as LC-PUFAs, vitamins and polyphenols oxidize in the presence of oxygen, especially in the presence of iron. Lipid oxidation influences the quality of food products through flavour and taste deterioration and reduction in nutritional value. Off-flavour and off-taste formation such as rancidity, fishiness, metallic, fried fat, etc, results mainly from the degradation of primary oxidation products of LC-PUFA, such as peroxides, which can readily isomerise and degrade to produce volatile compounds. The deterioration of sensory properties is a major cause of consumer complaints in the food industry. Furthermore, shelf-life can be significantly impaired upon oxidation of sensitive compounds. Oxidation of vitamins and polyphenols may also significantly reduce the nutritional value of these nutrients. Significant colour changes are also observed upon oxidation of polyphenols, for example.

As a result of a growing interest for enrichment of food with LC-PUFAs, vitamins, polyphenols and further compounds sensitive to oxidation, bringing significant nutritional benefits, a lot of work has been reported on the development of technologies able to reduce degradation of such compounds.

Focus has been put on masking agent and flavour for avoiding the fishy off notes generated by lipid oxidation in food matrices. However, flavour & masking agents do not stabilize the lipids such as LC-PUFAs, consequently the resulting oxidation leads to a reduction of the nutritional value.

Appropriate process & packaging should also decrease the rate of oxidation of sensitive compounds in food matrices e.g. via a separation of sensitive compounds or iron from the rest of the food matrix. However, this solution is really expensive and not applicable for every type of product.

Some solutions are based on ingredients able to stabilize sensitive compounds, such as encapsulation technologies or specific antioxidants. However, these solutions are preferably specific for the selected type of food matrices, and are tailored around one specific encapsulated ingredient only.

Specific iron sources have been found having reduced oxidative impact on LC-PUFAs. This is for example the case of ferric saccharate (WO 2015/097113). Ferric saccharate is however less bioavailable than for example ferrous sulphate. WO00/51446 has also described complexes formed of ferric ions and caseinate, which had good stability, caused little oxidation of sensitive compounds and had good bioavailability. However such complexes have the significant drawback of forming precipitates at high levels of iron addition and of forming haze when used in transparent beverages and solutions. The different drawbacks of the solutions provided by the prior art show that it is difficult to find iron sources having reduced oxidative potential, while having good bioavailability and while being soluble and providing good sensory attributes to the product in which they are incorporated.

Thus, an object of the present invention is to provide compositions comprising high amounts of an added iron source and high amounts of at least one compound sensitive to oxidation selected from LC-PUFAs, vitamins and polyphenols, in which oxidation of the sensitive compounds by iron is minimized, while providing a highly bioavailable iron source.

### SUMMARY OF THE INVENTION

The present inventors have surprisingly found that non-micellar iron-casein complexes comprising exogenous iron, casein and exogenous orthophosphorus, when used as iron source in a composition containing at least one compound sensitive to oxidation selected from LC-PUFAs, vitamins, polyphenols and mixtures thereof, do not cause significant oxidation of the sensitive compounds.

In a first aspect, the invention provides a composition comprising at least one compound sensitive to oxidation selected from LC-PUFAs, vitamins, polyphenols and mixtures thereof and an iron source, characterized in that the iron source is a non-micellar iron-casein complex comprising exogenous iron, casein and exogenous orthophosphorus.

In a second aspect, the invention relates to the use of an iron source for the fortification of a composition comprising at least one compound sensitive to oxidation selected from LC-PUFAs, vitamins, polyphenols and mixtures thereof, characterized in that the iron source is a non-micellar iron-casein complex comprising exogenous iron, casein and exogenous orthophosphorus.

In a third aspect, the invention provides a method for providing a nutrition to an individual comprising feeding the individual with an edible composition of the invention.

In a fourth aspect, the invention provides an edible composition comprising at least one compound sensitive to oxidation selected from LC-PUFAs, vitamins, polyphenols and mixtures thereof and an iron source, for use in the prevention, reduction and/or treatment of iron deficiency in an individual, characterized in that the iron source is a non-micellar iron-casein complex comprising exogenous iron, casein and exogenous orthophosphorus.

In an fifth aspect, the invention provides a method for reducing and/or preventing the oxidation of at least one compound sensitive to oxidation selected from LC-PUFAs, vitamins, polyphenols and mixtures thereof in a composition comprising an added iron source, characterized in that a non-micellar iron-casein complex comprising exogenous iron, casein and exogenous orthophosphorus is used as the added iron source.

In a sixth aspect, the invention provides a composition of the invention for use in the prevention, amelioration or treatment of malnutrition, metabolic diseases and/or neuro-degenerative diseases.

In a seventh aspect, the invention provides a composition of the invention for use in the promotion of the development of the nervous system and/or of the retina, in the promotion and/or improvement of the mental performance, behavioural and visual functions of an infant or a child, for strengthening immunity, including the development of gut microflora, and/or for reducing the risk of the development of overweight, obesity and insulin resistance.

### BRIEF DESCRIPTION OF THE DRAWINGS

FIG. 1: Graphic representation of the perception of fishy off-notes in compositions having 300 mg of DHA from fish oil and 15 mg of iron, per 100 g of composition. Two different iron sources are compared: dissolved ferrous sulphate in spray-dried form (Sample A) and a non-micellar iron-casein complex comprising exogenous iron, casein and exogenous orthophosphorus (Sample B). The development of fishy off note is significantly lower with the non-micellar iron-casein complex, indicating that the DHA is significantly less subject to oxidation when the complex is used as an iron source. The reference, with no fish oil and no iron, is completely devoid of fishy off-note.

FIG. 2: Graphic representation of the perception of fishy off-notes in compositions having 300 mg of DHA from microalgae oil and 15 mg of iron per 100 g of composition. Two different iron sources are compared: ferric pyrophosphate (Sample C) and a non-micellar iron-casein complex comprising exogenous iron, casein and exogenous orthophosphorus (Sample D). The development of fishy off note is significantly lower with the non-micellar iron-casein complex, indicating that the DHA is significantly less subject to oxidation when the complex is used as an iron source. The reference, with no fish oil and no iron, is completely devoid of fishy off-note.

### DETAILED DESCRIPTION OF THE INVENTION

### Definitions

As used herein, the terms “iron-casein complex” designate a complex formed of iron cations chelated with casein.

The term “iron” is herein intended as designating either Fe²⁺ or Fe³⁺, depending on the iron source used, unless otherwise specified.

An “added iron source” is intended for the purpose of the present invention as a ferrous or ferric compound added to the composition for the sole benefit of iron supplementation. Depending on its nature, the composition may comprise iron coming from other ingredients, for example from milk, fruit, vegetable, cereal or fibre components. Iron present in such ingredients is not intended here as an “added iron source”, because it is inherently present in an ingredient that is not primarily added for its iron content, but for its overall nutritional value.

An iron source is intended for the purpose of the present invention as being “substantially the only added iron source” in the composition, provided that other added iron sources are used in a sufficiently small amount not to cause statistically significant oxidation of LC-PUFAs, vitamins and/or polyphenols. The skilled person can assess whether a statistically significant loss of LC-PUFAs, vitamins and/or polyphenols is caused by applying the method described in the examples of the present application and applying commonly known statistical techniques for the analysis of the results.

The term “exogenous”, when referring to iron or phosphorus in the complex refers to iron and/or phosphorus that has been added during the process of production of the complex and thus it refers to iron or phosphorus that was not natively chelated with the casein.

The term “nutritional composition” designates a product intended to provide a complete nutrition or a supplemental nutrition to an individual (i.e. to fulfil essential nutritional needs of such individual) and in which the prominent objective is to provide nutrition. A nutritional composition aims at providing specific nutrients to an individual having special nutritional needs, such as infants, young children, pregnant or lactating women, elderly people or people with adverse medical condition requiring special food (e.g. tube feeding compositions or compositions for paediatric subjects). Products in which the hedonic aspect is prominent and nutritional qualities are not of primary importance are excluded from the “nutritional products”. Nutritional compositions preferably comprise proteins, fats, carbohydrates and diverse micro-nutrients.

In the present invention, the term “infant” means a child between birth and 12 months of age. The terms “young child” refer to a child between 12 months and 5 years of age, preferably between 12 months and 3 years of age.

The expression “infant formula” as used herein refers to a foodstuff intended for particular nutritional use by infants and satisfying by itself the nutritional requirements of this category of person (Article 2(c) of the European Commission Directive 91/321/EEC 2006/141/EC of 22 Dec. 2006 on infant formulae and follow-on formulae). It also refers to a nutritional composition intended for infants and as defined in Codex Alimentarius (Codex STAN 72-1981) and Infant Specialities (incl. Food for Special Medical Purpose). The infant formulas can encompass the starter infant formulas and the follow-up or follow-on formulas. Generally a starter formula is for infants from birth as breast-milk substitute. A follow-up or follow-on formula is given from the 6th month onwards. It constitutes the principal liquid element in the progressively diversified diet of this category of person. It is to be understood that infants can be fed solely with infant formulas, or that the infant formula can be used as a supplement or complement of human milk.

The “growing-up milks” (or GUMs) are given from one year onwards. It is generally a milk-based beverage adapted for the specific nutritional needs of young children.

The expression “baby food” means a foodstuff intended for particular nutritional use by infants or children such as young children, during the first years of life.

The expression “infant cereal composition” means a cereal-based foodstuff intended for particular nutritional use by infants or children such as young children, during the first years of life.

The term “fortifier” refers to nutritional compositions suitable for mixing with breast milk or infant formula. The “breast milk” should be understood as the mother's milk or the colostrum of the mother or a donor's milk or the colostrum of a donor's milk.

The term “supplement” refers to a composition that can be used to supplement, or complement, the nutrition of an individual.

The term “prebiotic” means non-digestible carbohydrates that beneficially affect the host by selectively stimulating the growth and/or the activity of healthy bacteria in the colon of humans (Gibson G R, Roberfroid M B. Dietary modulation of the human colonic microbiota: introducing the concept of prebiotics. J Nutr. 1995; 125:1401-12).

As used herein, the term “probiotic bacteria” refers to bacterial cell preparations with a beneficial effect on the health or well-being of the host [Salminen S, et al., “Probiotics: how they should be defined”, Trends Food Sci. Technol, (1999), 10, 107-10].

### Composition

The composition of the present invention comprises at least one compound sensitive to oxidation selected from LC-PUFAs, vitamins, polyphenols and mixtures thereof and an iron source, said iron source being a non-micellar iron-casein complex comprising exogenous iron, casein and exogenous orthophosphorus.

Casein can be obtained from diverse sources like milk, sodium caseinate, potassium caseinate, ammonium caseinate, rennet caseinate, acid casein, such as lactic casein, non-fat milk solids, casein derivatives, casein fractions or mixtures thereof. Preferably, it is sodium caseinate, potassium caseinate, ammonium, lactic casein casein derivatives, casein fractions or mixtures thereof.

In an embodiment, the casein is derived from a milk source having a ratio of protein to calcium that is of at least 45:1. Preferably the protein/calcium w/w ratio in the milk source is of at least 58:1, more preferably it is of 58:1 to 640:1, most preferably it is of 70:1 to 95:1. This represents a significant decrease of the amount of calcium in the milk source, as cow milk normally has a protein/calcium w/w ratio of 26:1. In another preferred embodiment, the milk protein is derived from a milk source wherein at least 70% w/v of the calcium has been removed from the milk source. Such milk source is preferably selected from whole milk, skimmed milk, low lactose milk, ultrafiltration retentate, concentrated milk and combinations thereof. In an embodiment the milk is bovine milk. Removal of calcium from the milk source is advantageous in that it helps in the binding of higher amounts of iron to the casein, namely by removing the chelated calcium, which can be replaced by iron.

In another preferred embodiment the protein to orthophosphorus w/w ratio is form 64:1 to 6.25:1, preferably less than 32:1 to 6.25:1, preferably from less than 32:1 to 8:1, more preferably from 28:1 to 8:1, even more preferably from 25:1 to 8:1, most preferably from 20:1 to 8:1. The presence of exogenous orthophosphorus is advantageous in that it helps in the effective binding of iron to the casein, thus contributing to the binding or high amounts of iron in the complexes.

In another preferred embodiment, the complex is soluble in a solution at physiological pH, preferably between pH 6.6 and 6.9. Such solubility is beneficial to avoid formation of insoluble precipitates in liquid solution at such pH and also contributes to the good bioavailability to the complex.

Preferably the complex comprises more than 1% w/w of bound iron, more preferably from 1 to 20% w/w of bound iron, even more preferably, 1 to 8% w/w, most preferably from 4 to 8% w/w of bound iron. More preferably the w/w ratio of casein to iron is of 92:1 to 19.5:1, preferably of 90:1 to 19.5:1, more preferably of 80:1 to 19.5:1, most preferably of 50:1 to 19.5:1. It is particularly advantageous to be able to have such high amounts of iron bound to the casein in the complex because the higher the iron load in the complex, the smaller the amount of complexes needed to fortify the composition.

In a preferred embodiment the iron in the complex is in the form of Fe³⁺.

Particularly preferred complexes are those described in US 2015/0164123, which is herein incorporated by reference. Such document provides detailed description of processes that can be used to produce complexes such as those described above and particular embodiments of complexes that can advantageously be used for the purpose of the present invention.

The above-described complexes are particularly advantageous in that they are soluble in aqueous liquid food products or beverages even when high amounts of iron are bound to the casein in the complexes. The complexes thus advantageously do not form insoluble precipitates, which would generate haze when added to transparent beverages and solutions and which may provide undesirable sandy texture to food products and beverages. Further advantages of the above-described complexes can be found in the cited reference document US 2015/0164123.

Now, the present inventors have found that most iron sources, such as the widely used ferrous sulphate heptahydrate and dissolved ferrous sulphate in spray-dried form, cause significant oxidation of sensitive compounds such as LC-PUFAs, vitamins and minerals, whereas significantly reduced oxidation is caused by the iron-casein complexes such as described herein.

This positive effect is observed when the iron-casein complex is used as such and as well when such complexes are dispersed in an amorphous matrix, provided that the complexed structure remains. Such ingredient with complexes dispersed in a matrix can be obtained by mixing the complexes with a carrier solution and spray-drying the carrier solution. Suitable carrier comprise for example maltodextrin. The person skilled in the art can routinely assess if a product or ingredient comprises iron-casein complexes by combining a protein identification assessment such as SDS-PAGE, mineral analysis using ICP atomic emission spectroscopy as well as by doing a “free iron” test with a compound such as potassium hexacyanoferrate that involves colour changes in the presence of Fe²⁺ and Fe³⁺.

The use of the above-described iron-casein complexes is particularly advantageous, in that they are characterized at the same time by good bioavailability and by low oxidative potential. It has been shown that non-micellar iron-casein complexes comprising exogenous iron, casein and exogenous orthophosphorus, as defined above, are characterized by a bioavailability similar to that of ferrous sulphate, which is the golden standard in terms of bioavailability in human. See for example in US 2015/0164123.

In a preferred embodiment, at least 50 wt %, more preferably at least 60 wt %, more preferably at least 70 wt %, more preferably at least 80 wt %, even more preferably at least 90 wt % of the added iron is in the form of a non-micellar iron-casein complex comprising exogenous iron, casein and exogenous orthophosphorus as defined above. Even more preferably, the iron-casein complex as defined above is substantially the only added iron source in the composition. Most preferably, the iron-casein complex as defined above is the only added iron source in the composition.

The added iron source is preferably present in an amount such as to provide from 6 to 50 mg, preferably 6 to 20 mg, more preferably 6 to 18 mg, more preferably 6 to 15 mg, or from 8 to 20 mg, preferably 8 to 18 mg, more preferably 8 to 15 mg of iron, per 100 g of composition, based on the total dry weight of the composition.

Preferred LC-PUFAs comprise docosahexaenoic acid (DHA, fatty acid 22:6n-3) and eicosapentaenoic (EPA, fatty acid 22:5n-3). The most preferred LC-PUFA is DHA. Suitable sources of LC-PUFA include fish oil and microbial oil, such as microalgae oil. The LC-PUFAs are preferably present in the composition in an amount of 10 to 500 mg, preferably 50 to 500 mg, more preferably 100 to 500 mg, even more preferably 200 to 500 mg, or in an amount of 10 to 450 mg, preferably 50 to 450 mg, more preferably 100 to 450 mg, most preferably 200 to 450 mg, of LC-PUFA per 100 g of composition based on the total dry weight of the composition.

In a preferred embodiment, the iron is present in the composition in an amount of 0.1 to 10 g, preferably 0.5 to 10 g, more preferably 1 to 10 g, even more preferably 2 to 10 g, most preferably 0.1 to 8 g, or 0.1 to 6 g, preferably 0.1 to 5 g, or 1 to 8 g, preferably 1 to 6 g, most preferably 1 to 5 g of iron per 100 g of LC-PUFA, preferably per 100 g of DHA. Such high amounts of iron per 100 g of LC-PUFA, preferably per 100 g of DHA, are a real challenge and are rendered possible by the particularly low oxidation potential of the iron casein-complexes described herein and by their ability to have high amount of iron bound in the each complex.

For the purpose of the present invention vitamins are preferably selected from Vitamin A, C, D, E and mixtures thereof, which are particularly sensitive to oxidation. Most preferably the vitamins are selected from vitamin A, vitamin C and mixtures thereof. In a preferred embodiment, vitamin A is present in the composition in an amount of 200 to 1000 IU/100 Kcal. In another preferred embodiment, vitamin C is present in an amount of 10 to 100 mg/100 Kcal.

Preferred polyphenols are flavonols. Flavonols are preferably present in an amount of 500 to 5000 mg per 100 g of composition.

In preferred embodiment, the at least one compound sensitive to oxidation is encapsulated. Preferably it is microencapsulated. When LC-PUFA are present in the composition such LC-PUFAs are preferably in whole or in part encapsulated in a glassy matrix of dairy proteins and glucose. Such a glassy matrix of dairy proteins and glucose can be prepared from any dairy protein available and suitable for this purpose, e.g. whey protein, casein, caseinate, milk proteins, β-lactoglobulin, α-lactalbumin, etc. Encapsulation may be carried out using techniques known in the art. Preferably LC-PUFA is encapsulated in a glassy matrix of dairy proteins and glucose as described in WO 2011/008097 A1 of Friesland Brands B.V., NL or can be obtained from FrieslandCampina Kievit under the trade name NIF powder.

The composition may be in liquid or in powder from. Preferably it is in powder form. When the composition is in powder form, it may be in the form of free powder or in the form of compressed powder, such as in the form of a tablet. Preferably the composition in powder form is not intended to be used in the form of a powder, but is to be reconstituted in a liquid, preferably in an aqueous liquid, most preferably in water, before use.

Preferred compositions of the invention include a food or beverage product, an animal feed product, a nutritional supplement for human or animal, a pharmaceutical composition or a cosmetic composition.

In another preferred embodiment, the composition is an edible composition.

Food and beverage products include all products intended to be consumed orally by human beings, for the purpose of providing nutrition and/or pleasure. In a preferred embodiment, the product is a nutritional composition. More preferably it is a nutritional composition selected from an infant formula, a growing-up milk, a baby food, an infant cereal composition, a fortifier, a supplement and a nutritional composition for pregnant or lactating women. More preferably, it is selected from an infant formula, a growing-up milk, an infant cereal composition and a nutritional composition for pregnant or lactating women.

The product can also be in the form of an animal feed product or a nutritional supplement for animals. Preferably, the animal is a mammal. Examples of animals include primates, cows, sheep, goats, horses, dogs, cats, rabbits, rats, mice, fish, birds and the like.

Nutritional supplements are intended to be consumed as such or to be added to food or to a beverage. Such supplements are intended to provide additional nutrients and/or a health benefit to the subject consuming it, as well as other beneficial ingredients, including LC-PUFA, vitamins and/or polyphenols and iron. A supplement according to the present invention can be used for providing nutrients and/or a health benefit to human beings, as well as to animals, as defined above. Nutritional supplements include for example supplements to be added to breast milk, for example for premature or low birth weight infants. It also includes supplements for women pre-pregnancy, during pregnancy and/or during lactation.

Pharmaceutical compositions are compositions intended to treat or to prevent an adverse medical condition in a subject in need thereof.

Cosmetic compositions are typically intended for an aesthetic effect on the body and may preferably be administered by oral route.

The composition, preferably the nutritional composition, preferably comprises protein, carbohydrates, fats, vitamins and/or other minerals. Preferably, it comprises all of these types of nutrients.

The proteins may be intact or hydrolysed (extensively or partially hydrolysed).

The nutritional composition according to the present invention generally contains a source of lipids, in addition to the LC-PUFAs that the composition may comprise. This is particularly relevant if the nutritional composition of the invention is an infant formula. In this case, the lipid source may be any lipid or fat which is suitable for use in infant formulae, in products for small children and/or in products for women during pregnancy, during lactation and pre-pregnancy. Some suitable fat sources include palm oil, high oleic sunflower oil and high oleic safflower oil. The essential fatty acids linoleic and α-linolenic acid may also be added.

The composition according to the present invention may contain a carbohydrate source, such as lactose, maltodextrin, starch and mixtures thereof. The composition according to the present invention may also contain a particular type of carbohydrates: prebiotics. The prebiotics that may be used in accordance with the present invention are not particularly limited and include all food substances that promote the growth of probiotics or health beneficial micro-organisms in the intestines. Preferably, they may be selected from the group consisting of oligosaccharides, optionally containing fructose, galactose, and mannose; dietary fibers, in particular soluble fibers, soy fibers; inulin; or mixtures thereof. Some examples of prebiotics are fructo-oligosaccharides (FOS), galacto-oligosaccharides (GOS), isomalto-oligosaccharides (IMO), xylo-oligosaccharides (XOS), arabino-xylo oligosaccharides (AXOS), mannan-oligosaccharides (MOS), inulin, polydextrose, glycosylsucrose (GS), lactosucrose (LS), lactulose (LA), palatinose-oligosaccharides (PAO), malto-oligosaccharides, gums and/or hydrolysates thereof, pectins and/or hydrolysates thereof. In a particular embodiment, the prebiotics may be fructooligosaccharides and/or inulin. Suitable commercial products that can be used include combinations of FOS with inulin such as the product sold by BENEO under the trademark Orafti, or polydextrose sold by Tate & Lyle under the trademark STA-LITE®.

The prebiotics can also be a BMO (bovine's milk oligosaccharide) and/or a HMO (human milk oligosaccharide) such as N-acetylated oligosaccharides, sialylated oligosaccharides, fucosylated oligosaccharides and any mixtures thereof.

A particular example of prebiotic is a mixture of galacto-oligosaccharide(s), N-acetylated oligosaccharide(s) and sialylated oligosaccharide(s) in which the N-acetylated oligosaccharide(s) represent 0.5 to 4.0 wt % of the oligosaccharide mixture, the galacto-oligosaccharide(s) represent 92.0 to 98.5 wt % of the oligosaccharide mixture and the sialylated oligosaccharide(s) represent 1.0 to 4.0 wt % of the oligosaccharide mixture. For example a composition for use according to the invention can contain from 2.5 to 15.0 wt % CMOS-GOS on a dry matter basis with the proviso that the composition comprises at least 0.02 wt % of an N-acetylated oligosaccharide, at least 2.0 wt % of a galacto-oligosaccharide and at least 0.04 wt % of a sialylated oligosaccharide. WO2006087391 and WO2012160080 provide some examples of production of such an oligosaccharide mixture.

The composition may also comprise probiotics microorganisms, preferably probiotic bacteria. Any probiotic bacteria can be used in the composition of the invention, preferably live probiotic bacteria. The composition of the invention advantageously comprises live probiotic bacteria in addition to the at least one compound sensitive to oxidation, because the iron-casein complex described herein has been shown not to be detrimental to the viability of probiotic bacteria, contrary to many iron sources, such as the commonly used ferrous sulphate heptahydrate and dissolved ferrous sulphate in spray-dried form. In embodiments where probiotic bacteria are present together with the compound sensitive to oxidation, the composition of the present invention is preferably in powder form and more preferably it is a composition in powder form to be reconstituted with a liquid such as water.

Examples of probiotic bacteria that can be present in the composition of the present invention include bifidobacteria, lactobacilli, lactococci, enterococci, streptococci, Leuconostoc, Escherichia, propionibacteria, or combinations thereof, preferably it is a bacteria of the Lactobacillus or of the Bifidobacterium genus.

Preferably the probiotic bacteria is selected among the species Bifidobacterium longum, Bifidobacterium lactis, Bifidobacterium animalis, Bifidobacterium breve, Bifidobacterium infantis, Bifidobacterium adolescentis, Lactobacillus acidophilus, Lactobacillus casei, Lactobacillus paracasei, Lactobacillus salivarius, Lactobacillus rhamnosus, Lactobacillus johnsonii, Lactobacillus plantarum, Lactobacillus fermentum, Lactobacillus reuteri, Lactococcus lactis, Streptococcus thermophilus, Lactococcus diacetylactis, Lactococcus cremoris, Lactobacillus delbrueckii subsp. bulgaricus, Lactobacillus delbrueckii subsp. lactis, Lactobacillus helveticus, Escherichia coli, Enterococcus faecium, Leuconostoc pseudomesenteroides, Bifidobacterium bifidum, Lactobacillus gasseri, Lactobacillus sakei, Streptococcus salivarius, as well as any of their subspecies and/or mixtures thereof.

More preferably, it is selected from the species Bifidobacterium longum, Bifidobacterium lactis, Bifidobacterium animalis, Bifidobacterium breve, Bifidobacterium infantis, Bifidobacterium adolescentis, Lactobacillus acidophilus, Lactobacillus casei, Lactobacillus paracasei, Lactobacillus salivarius, Lactobacillus rhamnosus, Lactobacillus johnsonii, Lactobacillus plantarum, Lactobacillus fermentum, Lactobacillus reuteri, Lactobacillus delbrueckii subsp. bulgaricus, Lactobacillus delbrueckii subsp. lactis, Lactobacillus helveticus, Bifidobacterium bifidum, Lactobacillus gasseri, Lactobacillus sakei and mixtures thereof.

Examples of bacterial strains that can advantageously be present in the composition include Bifidobacterium longum (deposited as ATCC BAA-999), Bifidobacterium longum (deposited as CNCM I-2618), Bifidobacterium breve (deposited as CNCM I-3865), Bifidobacterium lactis (deposited as CNCM I-3446), Lactobacillus johnsonii (deposited as CNCM I-1225), Lactobacillus paracasei (deposited as CNCM I-2116), Lactobacillus rhamnosus (deposited as CGMCC 1.3724), Streptococcus thermophilus (deposited as CNCM I-1422), Streptococcus thermophilus (deposited as CNCM I-4153), Streptococcus thermophilus (deposited as CNCM I-1985), Streptococcus thermophilus (deposited as CNCM I-3915), Lactobacillus casei (deposited as CNCM I-1518), Lactobacillus casei (deposited as ACA-DC 6002), Escherichia coli Nissle (deposited as DSM 6601), Lactobacillus bulgaricus (deposited as CNCM I-1198), Lactococcus lactis (deposited as CNCM I-4154), or combinations thereof.

More preferred bacterial strains include Bifidobacterium longum (deposited as ATCC BAA-999), Bifidobacterium longum (deposited as CNCM I-2618), Bifidobacterium breve (deposited as CNCM I-3865), Bifidobacterium lactis (deposited as CNCM I-3446), Lactobacillus johnsonii (deposited as CNCM I-1225), Lactobacillus paracasei (deposited as CNCM I-2116), Lactobacillus rhamnosus (deposited as CGMCC 1.3724), Lactobacillus casei (deposited as CNCM I-1518), Lactobacillus casei (deposited as ACA-DC 6002), Streptococcus thermophilus (deposited as CNCM I-3915) and Lactobacillus bulgaricus deposited as (CNCM I-1198) or combinations thereof.

In a further preferred embodiment the probiotic bacteria is selected from Bifidobacterium longum (deposited as ATCC BAA-999), Lactobacillus rhamnosus (deposited as CGMCC 1.3724) and Lactobacillus paracasei (deposited as CNCM I-2116) and mixtures thereof.

The probiotic bacteria is preferably present in the composition in an amount of at least 5E+06 CFU per gram of composition, on a dry weight basis, preferably 5E+06 to 1E+12 CFU per gram of composition, more preferably 5E+06 to 5E+11 CFU per gram of composition, most preferably 5E+06 to 5E+10 CFU per gram of composition.

The selected probiotic bacteria may be cultured according to any suitable method and prepared for addition to the composition by known techniques such as freeze-drying or spray-drying for example. Alternatively, bacterial preparations can be bought from specialist suppliers such as DSM, Dupont Danisco, Morinaga, Institut Rosell, Christian Hansen and Valio, already prepared in a suitable form for addition to a composition in powder form.

The composition of the invention may also contain minerals and other micronutrients, understood to be essential in the daily diet and in nutritionally significant amounts. Minimum requirements have been established for certain minerals. Examples of minerals and other nutrients optionally present in the composition of the invention include folic acid, inositol, niacin, biotin, pantothenic acid, choline, calcium, phosphorus, iodine, magnesium, copper, zinc, manganese, chlorine, potassium, sodium, selenium, chromium, molybdenum, taurine, and L-carnitine. Minerals are usually added in salt form. The presence and amounts of specific minerals and other vitamins will vary depending on the intended target group.

### Process of Making a Composition

According to a further embodiment, the object underlying the present invention is therefore preferably also solved by a process for preparing a composition as defined herein. In this regard, said process may contain or comprise any of the amounts and ingredients as defined for the inventive composition.

According to a particularly preferred embodiment, the invention relates to a process for the preparation of a composition as described herein, which comprises the step of mixing or dry blending the ingredients as defined herein above to obtain a composition.

Said process, preferably further comprises the steps of
a) carrying out at least one heat treatment step of said mixture obtained after the mixing or dry blending the ingredients; and
b) optionally homogenizing the mixture before or after the heat treatment step.

Advantageously, said process includes steps such as heat treatment and homogenization which result in improved safety and quality of the product. In the compositions of the present invention, compounds sensitive to oxidation, as described above, are advantageously stabilized in such a way that oxidation is prevented or reduced even when the relatively aggressive process steps of heat treatment and homogenization are carried out. Therefore, the composition of the present invention retains good sensory and nutritional properties, as a consequence of limited oxidation of LC-PUFA, vitamins and/or polyphenols during heat treatment and homogenization.

The inventive process preferably results in a solid, liquid or semi-liquid/semi-solid composition. When the inventive composition is in solid form, such as a powder, the process should preferably include a drying step, such as a spray-drying, freeze drying or fluid bed agglomeration step. In a preferred embodiment, the composition is in the form of a powder.

### Use of a Non-Micellar Iron-Casein Complex Comprising Exogenous Iron, Casein and Exogenous Orthophosphorus for the Fortification of a Composition

Non-micellar iron-casein complexes comprising exogenous iron, casein and exogenous orthophosphorus can advantageously be used for the fortification of a composition comprising at least one compound sensitive to oxidation selected from LC-PUFAs, vitamins, polyphenols and mixtures thereof. Such iron sources advantageously provide bioavailable iron, while causing little oxidation of the sensitive compounds.

Non-micellar iron-casein complexes comprising exogenous iron, casein and exogenous orthophosphorus having a bioavailability similar to that of ferrous sulphate, as described above, they are particularly useful to fortify food products.

In another embodiment, the present invention relates to a method for fortifying a composition comprising at least one compound sensitive to oxidation selected from LC-PUFAs, vitamins, polyphenols and mixtures thereof, said method comprising addition to the composition a non-micellar iron-casein complex comprising exogenous iron, casein and exogenous orthophosphorus.

The composition is as defined in any embodiment of the “composition” section.

In a preferred embodiment, at least 50 wt %, more preferably at least 60 wt %, more preferably at least 70 wt %, more preferably at least 80 wt %, even more preferably at least 90 wt % of the added iron in the composition is in the form of a non-micellar iron-casein complex comprising exogenous iron, casein and exogenous orthophosphorus. Even more preferably, the non-micellar iron-casein complex comprising exogenous iron, casein and exogenous orthophosphorus is substantially the only added iron source in the composition. Most preferably, the non-micellar iron-casein complex comprising exogenous iron, casein and exogenous orthophosphorus is the only added iron source in the composition.

A Composition for Use in a Method to Prevent, Reduce and/or Treat Iron Deficiency

The composition of the invention being fortified with a non-micellar iron-casein complex comprising exogenous iron, casein and exogenous orthophosphorus, which is highly bioavailable, as described above, the present invention also relates to a composition for use in a method to prevent, reduce and/or treat iron deficiency in an individual.

### Method for Providing a Nutrition

A method for providing a nutrition to an individual comprising feeding the individual with an edible composition of the invention is also contemplated. The composition used in this method is a food or beverage composition. Preferably, it is a nutritional composition as defined above. Such edible compositions are particularly advantageous for providing a nutrition because they comprise a bioavailable source of iron and only low levels of oxidized LC-PUFAs, vitamins and/or polyphenols, which would have reduced nutritional value.

In an embodiment wherein the composition is in powder form, the method comprises the steps of
a) reconstituting an edible composition in powder form according to any of the embodiments of the invention; and
b) feeding an individual with the reconstituted composition.

In an embodiment, the individual is an individual having an iron deprivation or an individual at risk of developing an iron deprivation. In another embodiment, the individual is an infant, a young child, a woman during pregnancy, during lactation or pre-pregnancy, or an elderly person. More preferably, the individual is an infant, a young child or a woman during pregnancy, during lactation or pre-pregnancy.

### Method for Preventing or Reducing the Oxidation of Compounds Sensitive to Oxidation

The invention relates to a method for reducing and/or preventing the oxidation of at least one compound sensitive to oxidation selected from LC-PUFAs, vitamins, polyphenols and mixtures thereof in a composition comprising an added iron source, characterized in that a non-micellar iron-casein complex comprising exogenous iron, casein and exogenous orthophosphorus is used as the added iron source.

The compound sensitive to oxidation, the added iron source and the composition are as described in any embodiment of the “composition” section.

In a preferred embodiment, the non-micellar iron-casein complexes represent at least 50 wt %, more preferably at least 60 wt %, more preferably at least 70 wt %, more preferably at least 80 wt %, even more preferably at least 90 wt % of the added iron in the composition. More preferably the non-micellar iron-casein complexes are substantially the only added iron source used in the composition. Most preferably, the non-micellar iron-casein complexes are the only added iron source in the composition. In other words, the composition comprises no other ferrous or ferric compound added as an iron source in the composition.

The present inventors have shown that by using such complexes instead of other commonly added iron sources, such as ferrous sulphate heptahydrate or dissolved ferrous sulphate in spray-dried form, the oxidation of sensitive compounds such as LC-PUFAs, vitamins and/or polyphenols could be prevented or at least significantly reduced.

The added iron source has an important impact on the oxidation of sensitive compounds, whereas the impact of iron sources present as part of an ingredient that is not intended mainly for the purpose of iron supplementation is smaller, as the latter iron sources are often less reactive and iron provided by the latter iron source is usually provided in much lower amounts than that provided by the added iron source.

The level of oxidation of sensitive compounds can be assessed using well-known techniques, including the analysis of markers of oxidation. In the case of LC-PUFAs, the level of oxidation can also be assessed using sensory experiments. Preventing or reducing oxidation of LC-PUFAs is identified by reduction of off-taste, such as rancidity, fishiness, metallic, painty, fried fat, etc. in the composition, when compared to a composition comprising the same ingredients but another kind of iron source. Such an off-flavour can be tested and verified by a skilled person following accepted standards of sensory testing, such as the preference test. In the case of compositions comprising polyphenols, such as cocoa compositions, the level of oxidation can be assessed using a visual or analytical colorimetry evaluation.

### Further Second Medical Uses

The composition of the present invention, preferably comprising LC-PUFAs, may be used for prevention, amelioration or treatment of a disease or disorder as defined herein. As used herein, the term “a disorder” or “a disease” refers to any derangement or abnormality of function; a morbid physical or mental state. See Dorland's Illustrated Medical Dictionary, (W.B. Saunders Co. 27th ed. 1988). Such diseases or disorders may be selected from malnutrition, metabolic diseases, neurodegenerative diseases, Alzheimer disease/cognitive impairment, Parkinson's disease, neurological diseases, Amyotrophic lateral sclerosis, Traumatic brain injury, Hypoxic/ischemic brain injury, Autism, ADHD (Attention Deficit Hyperactivity Disorder), Depression, Headaches, Migraine Headaches, Narcolepsy, GLUT-1 deficiency, Pyruvate Dehydrogenase (PDH) deficiency, phosphofructokinase (PFK) deficiency, Glycogenosis type V (McArdle disease), Cardiac ischemia, Rett syndrome, Tuberous Sclerosis, Diabetes and Cancer (astrocytornas, prostate, gastric, renal, head and neck), preferably for use in the prevention, amelioration or treatment of malnutrition, metabolic diseases, neurodegenerative diseases, preferably as a nutritional supplement. The composition is preferably used as a nutritional composition or supplement.

The composition of the present invention, preferably comprising LC-PUFAs, may also be used for the promotion of the development of the nervous system and/or of the retina, and/or in the promotion and/or improvement of the mental performance, behavioural and visual functions of an infant or a child.

For the purpose of the present invention, mental performance is for example intended as cognitive and intellectual performance, memory, as well as language ability of an infant or child. Development of the nervous system is intended to include for example brain and neuronal development.

The composition of the present invention, preferably comprising LC-PUFs, may further be used to strengthen immunity, including the development of gut microflora.

The composition of the present invention, preferably comprising LC-PUFAs, furthermore can be used for reducing the risk of the development of overweight, obesity and insulin resistance.

The advantageous effects of the inventive composition as described above and preferably comprising LC-PUFAs, is preferably accomplished by administering an effective amount of a composition according to the present invention to a subject in need thereof. Preferably, such a composition is to be administered once daily, preferably twice daily, more preferably three times daily, wherein during administration preferably at least one unit or dose for administration is provided, as defined herein. Upon administration, preferably the total amount of energy to be administered per day is as defined before. As used herein, the term “subject” refers to an animal. Preferably, the animal is a mammal. A subject also refers to for example, primates (e.g., humans), cows, sheep, goats, horses, dogs, cats, rabbits, rats, mice, fish, birds and the like. In a preferred embodiment, the subject is a human, more preferably selected from an infant, a child or an adult. The term “effective amount” of a composition of the present invention refers to an amount of the compound of the present invention that will elicit the biological or medical response of a subject, enhance development of organs or functions of a subject, or ameliorate symptoms, slow or delay disease progression, or prevent a disease, etc. Preferably, such an “effective amount” is a packaged dose or unit as obtained as described herein.

The present invention will now be described in further details by the way of the following examples.

### Example 1: Effect of Iron Source on Oxidation of DHA from Fish Oil

Two powder compositions (Samples A and B) were prepared, each comprising DHA and an iron source in the amounts summarized in Table 1 below.

TABLE 1
Composition of Samples A and B

| Ingredient | Sample A | Sample B |
|---|---|---|
| DHA¹⁾ | 300 mg/100 g | 300 mg/100 g |
| Iron source used | Dissolved ferrous | Iron-casein |
| | sulphate in spray-dried | complex³⁾ |
| | form²⁾ | |
| Amount of iron provided | 15 mg/100 g | 15 mg/100 g |
| by the iron source | | |

¹⁾As part of fish oil.
²⁾Obtained by dissolving ferrous sulphate in water at pH2 and spray-drying in a maltodextrin matrix. This iron source contains 8.4 wt % of Fe²⁺.
³⁾FerriPro2, origin Riddet Institute, Massey University, New Zealand: iron-casein complex as defined as complex II in US 2015/0164123.

The Samples were produced as follows. A skimmed milk powder base containing milk fat, oil mix (combination of rapeseed oil, sunflower oil and corn oil) and LC-PUFA source (fish oil rich in DHA) was produced by an emulsion preparation followed by spray drying. The base powder was subsequently mixed with the iron source by dry blending process. The resultant powder was packaged into a tight packaging (tin can) with altered gassing condition that gave ˜5% initial residual oxygen concentration in the headspace.

Shelf life study was conducted at 30° C. and sensory evaluation was carried out by professionally-trained sensory panel (min. 14 people) at different time points. Prior to sensory evaluation, the powder product was reconstituted at 30 g powder in 180 ml at 40° C. with Vittel mineral water.

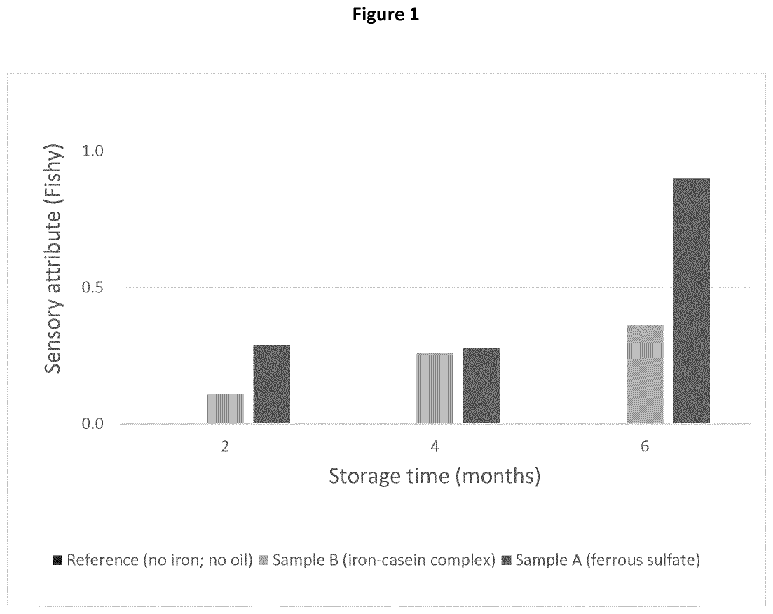

The results are summarized in FIG. 1. It is clear from this graph that the fishy off-note was significantly lower when the iron-casein complex was used as an iron source (Sample A) compared to Sample B, wherein ferrous sulphate in spray-dried form was used, indicating a significantly reduced oxidation of the DHA contained in the fish oil. The reference, with no fish oil and no iron, is completely devoid of fishy off-note.

### Example 2: Effect of Iron Source on Oxidation of DHA from Microalgae Oil

Two powder compositions (Samples C and D) were prepared, each comprising DHA and an iron source in the amounts summarized in Table 2 below.

TABLE 2
Composition of Samples C and D

| Ingredient | Sample C | Sample D |
|---|---|---|
| DHA¹⁾ | 300 mg/100 g | 300 mg/100 g |
| Iron source used | Ferric pyrophosphate | Iron-casein complex²⁾ |
| Amount of iron provided | 15 mg/100 g | 15 mg/100 g |
| by the iron source | | |

¹⁾As part of microalgae oil
²⁾FerriPro2, origin Riddet Institute, Massey University, New Zealand: iron-casein
complex as defined as complex II in US 2015/0164123.

The Samples were produced as follows. A skimmed milk powder base containing milk fat, oil mix (combination of rapeseed oil, sunflower oil and corn oil) and LC-PUFA source (microalgae oil rich in DHA) was produced by an emulsion preparation followed by spray drying. The base powder was subsequently mixed with the iron source by dry blending process. The resultant powder was packaged into a tight packaging (tin can) with altered gassing condition that gave ˜5% initial residual oxygen concentration in the headspace.

Shelf life study was conducted at 30° C. and sensory evaluation was carried out by professionally-trained sensory panel (min. 14 people) at different time points. Prior to sensory evaluation, the powder product was reconstituted at 30 g powder in 180 ml at 40° C. with Vittel mineral water.

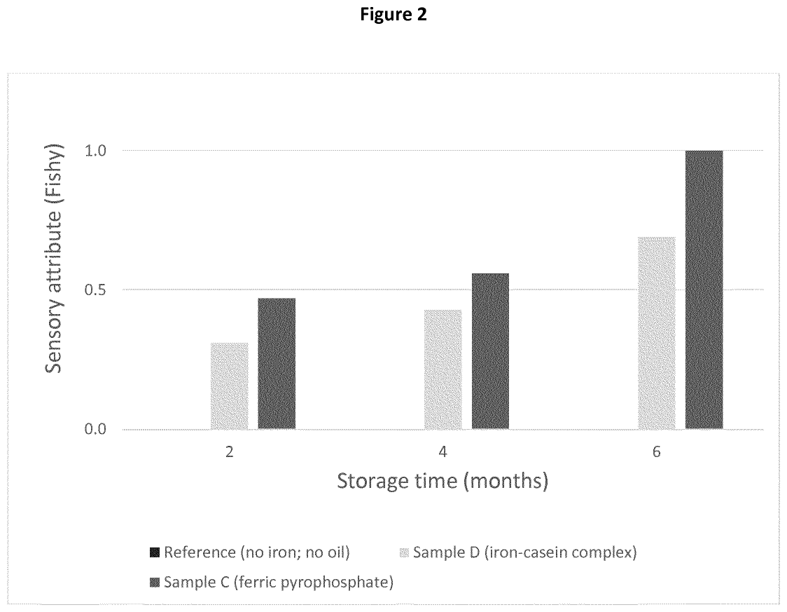

The results are summarized in FIG. 2. It is clear from this graph that the fishy off-note was significantly lower when the iron-casein complex was used as an iron source (Sample C) compared to Sample D, wherein ferric pyrophosphate was used, indicating a significantly reduced oxidation of the DHA contained in the fish oil. The reference, with no fish oil and no iron, is completely devoid of fishy off-note.

### Example 3: Effect of Iron Source on Oxidation of Polyphenols in a Chocolate Drink

Three samples (Samples E to G) were prepared, each comprising fish oil and an iron source in the amounts summarized in Table 3 below.

TABLE 3
Composition of Samples C and D

| Ingredient | Sample E | Sample F | Sample G |
|---|---|---|---|
| Iron source used | Dissolved ferrous | Iron-casein | Ferric |
| | sulphate in spray- | complex²⁾ | pyrophosphate |
| | dried form¹⁾ | | |
| Amount of iron | 42 mg/100 mL | 42 mg/100 mL | 0 mg/100 mL |
| provided by the | | | |
| iron source | | | |

¹⁾Obtained by dissolving ferrous sulphate in water at pH2 and spray-drying in a maltodextrin matrix. This iron source contains 8.4 wt % of Fe²⁺.
²⁾FerriPro2, origin Riddet Institute, Massey University, New Zealand: iron-casein complex as defined as complex II in US 2015/0164123.

The Samples were produced as follows. Commercial Nesquik RTD low fat chocolate drink was purchased from a supermarket in Switzerland. An amount of 4.2 mg of iron was added to 100 mL of the Nesquik drink and the drink was then heat treated at 75-80° C. for 10 mins. The colour of the drink was evaluated once the sample had cooled down to room temperature as well as after 24 hours of storage at 4° C.

Evaluation by colour performance showed iron-induced darkening of the beverage when ferrous sulphate (Sample E) was used (due to reaction of ferrous ions with cocoa polyphenols). Sample F in which the iron-casein complex was used, showed similar colour performance as the reference (Sample G) comprising insoluble ferric pyrophosphate, which is known to cause little oxidation of polyphenols.

1. A composition comprising at least one compound sensitive to oxidation selected from LC-PUFAs, vitamins, polyphenols and mixtures thereof and an iron source, wherein the iron source is a non-micellar iron-casein complex comprising exogenous iron, casein and exogenous orthophosphorus.

2. A composition according to claim 1, wherein the iron in the iron-milk protein complex is in the form of Fe³⁺.

3. A composition according to claim 1, wherein the protein to orthophosphorus w/w ratio in the complex is form 64:1 to 6.25:1.

4. A composition according to claim 1, wherein the complex is soluble at physiological pH, preferably between 6.6 and 6.9.

5. A composition according to claim 1, wherein the complex comprises more than 1% w/w of bound iron.

6. A composition according to claim 1, wherein the w/w ratio of casein to iron is between 92:1 and 19.5:1.

7. A composition according to claim 1, wherein the composition is a nutritional composition.

8. A composition according to claim 1, wherein the iron source is present in an amount such as to provide 6 to 50 mg of iron per 100 g of composition.

9. A composition according to claim 1, wherein the composition comprises
a. 10 to 500 mg of LC-PUFA per 100 g, based on the total dry weight of the composition;
b. 200 to 1000 IU of vitamin A per 100 Kcal;
c. 10 to 100 mg of vitamin C per 100 Kcal; and
d. 500 to 5000 mg of flavonols per 100 g, based on the total dry weight of the composition.

10. An iron source comprising at least one compound sensitive to oxidation selected from LC-PUFAs, vitamins, polyphenols and mixtures thereof for use in fortification of a composition, wherein the iron source is a non-micellar iron-casein complex comprising exogenous iron, casein and exogenous orthophosphorus.

11. A method for use in a method of preventing, reducing and/or treating iron deficiency in an individual comprising administering an edible composition comprising at least one compound sensitive to oxidation selected from LC-PUFAs, vitamins, polyphenols and mixtures thereof and an added iron source, wherein the added iron source is a non-micellar iron-casein complex comprising exogenous iron, casein and exogenous orthophosphorus to an individual in need of same.

12-15. (canceled)
